(19) United States
(12) Patent Application Publication
(10) Pub. No.: US 2026/0297228 A1
(43) Pub. Date: Oct. 1, 2026

(54) METHOD FOR PREPARING ZIEGLER-NATTA CATALYST FOR POLYMERIZATION OF LOW-DENSITY COPOLYMER

(71) Applicants: SK INNOVATION CO., LTD., Seoul (KR); SK GEO CENTRIC CO., LTD., Seoul (KR)

(72) Inventors: Jinhaek YANG, Daejeon (KR); Mun Hyung KANG, Daejeon (KR); Maengsun EO, Daejeon (KR)

(21) Appl. No.: 18/880,566

(22) PCT Filed: May 10, 2023
(86) PCT No.: PCT/KR2023/006326

§ 371 Date: Jan. 2, 2025

(30) Foreign Application Priority Data
Jul. 4, 2022 (KR) 10-2022-0081656

(51) Int. Cl. C08F 210/16

(52) U.S. Cl. CPC C08F 210/16

(57) ABSTRACT

The present disclosure relates to a method for preparing a Ziegler-Natta catalyst for polymerization of a low-density copolymer, and in particular, to a method for preparing a Ziegler-Natta catalyst including preparing a magnesium support by reacting an alkyl aluminum compound in the presence of a branched alkyl alcohol or cycloalkyl alcohol solvent. Since the Ziegler-Natta catalyst prepared by the method for preparing a Ziegler-Natta catalyst according to an embodiment has excellent catalytic activity, it is possible to effectively produce a low-density copolymer that may have various physical properties and excellent copolymerization performance.

### TECHNICAL FIELD

The present disclosure relates to a method for preparing a Ziegler-Natta catalyst for polymerization of a low-density copolymer and a method for producing a low-density copolymer using the Ziegler-Natta catalyst prepared therefrom.

### BACKGROUND ART

A polymerization catalyst of the Ziegler-Natta (Z/N) type is a catalyst for producing an olefin polymer, for example, an ethylene copolymer. Typically, the Ziegler-Natta catalyst contains a magnesium compound, an aluminum compound, and a titanium compound supported on a specific support.

Since the shape and size of the polymer polymerized using the Ziegler-Natta catalyst depend on the catalyst used, it is important to prepare a catalyst that may increase productivity and may produce uniformly distributed polymers.

Although a lot of development work for the preparation of the Ziegler-Natta catalyst has been carried out, some methods are not amenable to large-scale preparation of catalysts because preparation conditions are significantly sensitive or a large amount of impurities or wastes is generated. U.S. Pat. No. 8,003,741 discloses a method for preparing a Ziegler-Natta catalyst in which a magnesium compound is dissolved in alcohol and then a titanium compound is added, but the preparation process is complicated and many types of materials are used.

### DISCLOSURE

### Technical Problem

An embodiment of the present disclosure is to provide a method preparing a Ziegler-Natta catalyst for polymerization of a low-density copolymer.

Another embodiment of the present disclosure is to provide a Ziegler-Natta catalyst for polymerization of a low-density copolymer prepared by the preparation method according to the embodiment.

Still another embodiment of the present disclosure is to provide a method for producing a low-density copolymer using the Ziegler-Natta catalyst for polymerization of a low-density copolymer according to the embodiment.

### Technical Solution

In one general aspect, a method for preparing a Ziegler-Natta catalyst for polymerization of a low-density copolymer comprises: adding a branched alkyl alcohol or cycloalkyl alcohol to a mixture of dialkyl magnesium and a compound represented by the following Chemical Formula 1 to prepare a solution containing a magnesium support; and adding a metal compound containing titanium (Ti) to the solution containing the magnesium support:

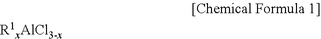

in Chemical Formula 1,
each R¹ is independently C₁₋₁₀ alkyl or C₃₋₁₀ cycloalkyl; and
x is 1 to 3.

In another general aspect, there is provided a Ziegler-Natta catalyst for polymerization of a low-density copolymer prepared by the method for preparing a Ziegler-Natta catalyst for polymerization of a low-density copolymer according to the embodiment.

In still another general aspect, a method for producing a low-density copolymer comprises bringing an olefin monomer into contact with the Ziegler-Natta catalyst for polymerization of a low-density copolymer according to the embodiment.

### Advantageous Effects

The present disclosure relates to a method for preparing a Ziegler-Natta catalyst for polymerization of a low-density copolymer, and in particular, to a method for preparing a Ziegler-Natta catalyst comprising preparing a magnesium support by reacting an alkyl aluminum compound in the presence of a branched alkyl alcohol or cycloalkyl alcohol solvent. Since the Ziegler-Natta catalyst prepared by the method for preparing a Ziegler-Natta catalyst according to an embodiment has excellent catalytic activity, it is possible to effectively produce a low-density copolymer that may have various physical properties and excellent copolymerization performance.

### DESCRIPTION OF DRAWINGS

FIG. 1 is a view showing results of analyzing polymers produced using Ziegler-Natta catalysts prepared in Examples and commercially available catalysts through crystallization elution fractionation (CEF).

FIG. 2 is a view showing results of observing forms of magnesium support solutions prepared in Examples 1-4, 3-4, 4-4, 5-4, and 6-4 and Comparative Examples 1-4, 2-4, and 3-4 through photographs.

FIG. 3 is a view showing results of observing forms of the magnesium support solution prepared in Example 1-4 and the prepared catalyst through photographs.

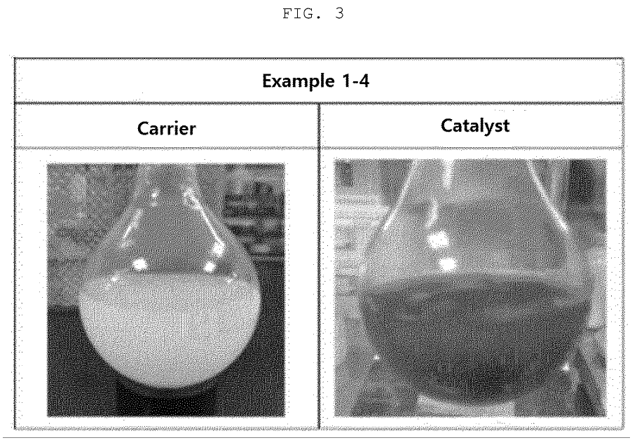

### BEST MODEL

Embodiments disclosed in the present specification may be modified into various different forms and the technology according to an embodiment is not limited to the embodiments described below. Furthermore, in the entire specification, unless explicitly described otherwise, “comprising” any components will be understood to imply the inclusion of other components rather than the exclusion of any other components.

A numerical range used in the present specification comprises upper and lower limits and all values within these limits, increments logically derived from a form and span of a defined range, all double limited values, and all possible combinations of the upper and lower limits in the numerical range defined in different forms. As an example, when a content of a composition is limited to 10% to 80% or 20% to 50%, a numerical range of 10% to 50% or 50% to 80% should also be interpreted as described in the present specification. Unless otherwise specifically defined in the present specification, values out of the numerical ranges that may occur due to experimental errors or rounded values also fall within the defined numerical ranges.

Hereinafter, unless otherwise specifically defined in the present specification, “about” may be considered a value within 30%, 25%, 20%, 15%, 10%, or 5% of a stated value.

Hereinafter, “alkyl” in the present specification is defined as being able to mean both alkyl and cycloalkyl. In addition, even if there is no specific definition, alkyl or cycloalkyl may be construed as comprising a derivative that may be expected to exert a similar effect and may be easily modified by those skilled in the art, or alkyl or cycloalkyl substituted with a general substituent (for example, halogen or the like).

A method for preparing a Ziegler-Natta catalyst according to an embodiment comprises reacting dialkyl magnesium with an alkyl aluminum compound in the presence of a branched alkyl alcohol and/or cycloalkyl alcohol solvent, such that it is possible to provide a method for preparing a Ziegler-Natta catalyst for polymerization of a low-density copolymer having significantly improved catalytic activity. In a case where a low-density copolymer is polymerized using the Ziegler-Natta catalyst prepared by the method for preparing a Ziegler-Natta catalyst according to an embodiment, a catalyst mileage may be significantly higher than that of a conventional catalyst prepared using a linear alkyl alcohol such as normal propyl alcohol as a solvent. In addition, the low-density copolymer polymerized using the Ziegler-Natta catalyst according to an embodiment has a low ratio of a high density region (homopolymer) and a high ratio of a low density region (copolymer) compared to the commercial products, such that the low-density copolymer has a high elongation and is excellent in utilization.

Hereinafter, the method for preparing a Ziegler-Natta catalyst for polymerization of a low-density copolymer according to an embodiment and polymerization of a low-density copolymer using the same will be described in detail. An embodiment provides a method for preparing a Ziegler-Natta catalyst for polymerization of a low-density copolymer, the method comprising: adding a branched alkyl alcohol and/or cycloalkyl alcohol to a mixture of dialkyl magnesium and a compound represented by the following Chemical Formula 1 to prepare a solution containing a magnesium support (magnesium support solution); and

adding a metal compound containing titanium (Ti) to the solution containing the magnesium support:

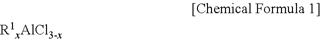

in Chemical Formula 1,
each R¹ is independently C₁₋₁₀ alkyl or C₃₋₁₀ cycloalkyl; and
x is 1 to 3.

According to the preparation method according to an embodiment, dialkyl magnesium and alkyl aluminum represented by Chemical Formula 1 react with each other in the presence of a branched alkyl alcohol or cycloalkyl alcohol solvent, such that a Ziegler-Natta catalyst having excellent catalytic activity may be prepared. Therefore, in a case where a low-density copolymer is polymerized using the Ziegler-Natta catalyst prepared according to an embodiment, a low-density copolymer may be produced with a significantly increased yield and/or catalyst mileage. In addition, since the catalyst has an excellent comonomer reactivity, the low-density copolymer produced using the catalyst may have excellent physical properties such as a high elongation because it has a high ratio of a low density region compared to a commercially available linear low-density copolymer produced by the conventional technologies.

Unlike a conventional magnesium support solution, the solution containing the magnesium support (or a magnesium support slurry solution) prepared by the method for preparing a Ziegler-Natta catalyst according to an embodiment is opaque, that is, has a lower solubility than the conventional transparent magnesium support solution. The magnesium support solution according to an embodiment may implement remarkable catalytic activity because it has such solubility characteristics. Specifically, the magnesium support according to an embodiment may significantly effectively contribute to implementation of high catalytic activity because it is significantly stable in physical properties. In addition, in the magnesium support according to an embodiment, as a transition metal is supported on the outside of the magnesium support, active sites of the transition metal are increased, such that the catalytic activity may be significantly increased. On the other hand, in the conventional magnesium support solution (Comparative Example 1) prepared transparently, the magnesium support and the catalyst are coprecipitated to form an incomplete support, and the active sites of the transition metal are reduced as the transition metal is supported on the inside and outside of the support, such that the catalytic activity is reduced.

The effect implemented in an embodiment as described above may be an effect implemented by using the branched alkyl alcohol and/or cycloalkyl alcohol as a solvent in the preparing of the magnesium support solution. The preparing of the solution containing the magnesium support is a step of forming a complex of magnesium and alcohol, and in this case, an alkyl group of the alcohol may be an important factor in the formation of the complex. In an embodiment, aluminum trialkoxides in the form of a trimer (three-molecular polymer) may be formed by using a branched alkyl-substituted or cyclic alkyl-substituted alcohol, and as a result, when the magnesium-alcohol complex is formed, the aluminum trialkoxides may further agglomerate with each other to form an insoluble slurry.

In an embodiment, the dialkyl magnesium may be magnesium substituted each independently with a linear or branched C₁₋₁₀ alkyl or C₃₋₁₀ cycloalkyl. Alternatively, the dialkyl magnesium may be substituted with two substituents independently selected from C₁₋₆ alkyl, C₁₋₅ alkyl, C₂₋₅ alkyl, —CH₃, —CH₂CH₃, —CH₂CH₂CH₃, —CH₂CH₂CH₂CH₃, C₃₋₆ cycloalkyl, C₄₋₆ cycloalkyl, and C₅₋₆ cycloalkyl. In an embodiment, the dialkyl magnesium may be ethyl normal butyl magnesium (BEM) (Et (n-Bu) Mg).

In an embodiment, the magnesium support may comprise an adduct or complex of magnesium and alcohol and/or alkyl. For example, the magnesium support may be represented by Mg(OR)₂·a [Al_{b}(OR)_{3b}]. In this case, a may be, for example, 0.1 to 10, 0.1 to 6, 0.5 to 6, 0.5 to 3, 0.8 to 2, 0.8 to 1.5, or 1. In addition, b may be, for example, 0.1 to 10, 0.1 to 6, 0.1 to 5, 0.1 to 3, 0.1 to 1, 0.2 to 0.8, or 0.5. For example, the magnesium support may be Mg(OR)·[Al_{0.5}(OR)_{1.5}]. In addition, R may be, for example, an alkyl group derived from alcohol, and therefore, R may be a branched alkyl group or cycloalkyl group.

In an embodiment, R¹'s may be each independently a linear or branched C₁₋₆ alkyl, C₁₋₅ alkyl, C₁₋₃ alkyl, —CH₃, —CH₂CH₃, —CH₂CH₂CH₃, —CH₂CH₂CH₂CH₃, —CH(CH₃) CH₂CH₃, C₃₋₆ cycloalkyl, C₄₋₆ cycloalkyl, or C₅₋₆ cycloalkyl, and in this case, all of R¹'s may be the same substituent. However, this is only an example, but R¹ is not limited thereto.

In an embodiment, x may be, for example, 1, 3/2, 2, 5/2, or 3. Specifically, the compound represented by Chemical Formula 1 may be trialkyl aluminum (R¹₃Al) in which x is 3. In an embodiment, the compound represented by Chemical Formula 1 may be triethyl aluminum (C₆H₁₅Al) or tributyl aluminum (C₁₂H₂₇Al) (or triisobutyl aluminum).

The preparation method according to an embodiment may be performed in the presence of a general organic solvent, and for example, may be performed in the presence of a C₅₋₂₀ saturated hydrocarbon solvent. Specifically, pentane, hexane, heptane, octane, nonane, decane, or a mixed solvent thereof may be used.

The preparation method according to an embodiment may further comprise, after the adding of the metal compound, adding a compound represented by the following Chemical Formula 2:

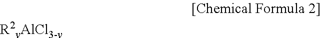

in Chemical Formula 2,
each R² is independently C₁₋₁₀ alkyl or C₃₋₁₀ cycloalkyl; and
y is 1 to 2.

In this case, R²'s may be each independently a linear or branched C₁₋₆ alkyl, C₁₋₅ alkyl, C₂₋₅ alkyl, —CH₃, —CH₂CH₃, —CH₂CH₂CH₃, —CH₂CH₂CH₂CH₃, C₃₋₆ cycloalkyl, C₄₋₆ cycloalkyl, or C₅₋₆ cycloalkyl, and in this case, all of R²'s may be the same substituent. However, this is only an example, but R² is not limited thereto.

In an embodiment, y may be, for example, 0, 1/2, 1, 3/2, or 2.

In an embodiment, the compound represented by Chemical Formula 2 may be ethyl aluminum sesquichloride (C₆H₁₅Al₂Cl₃, that is, (C₂H₅)_{3/2}AlCl_{3/2}), ethyl aluminum dichloride (EtAlCl₂), methyl aluminum dichloride (MeAlCl₂), propyl aluminum dichloride (PrAlCl₂), or butyl aluminum dichloride (BuAlCl₂), and one or more compounds may be used simultaneously or in combination. In an embodiment, the alkyl aluminum chloride compound represented by Chemical Formula 2 may be a monomer or dimer.

In an embodiment, a molar ratio of the metal compound to the compound represented by Chemical Formula 2 may be 1:0.1 to 1:15, 1:0.1 to 1:10, 1:1 to 1:10, 1:2 to 1:10, 1:2 to 1:8, 1:3 to 1:5, or about 1:5. However, this is only an example, but the molar ratio is not limited thereto.

In an embodiment, a molar ratio of the metal compound to the magnesium support may be 1:5 to 1:30, 1:5 to 1:30, 1:10 to 1:30, 1:10 to 1:25, 1:10 to 1:20, 1:12 to 1:18, or about 1:15. However, this is only an example, but the molar ratio is not limited thereto.

In an embodiment, the metal compound may further contain a transition metal, and for example, may further contain a Group IV or Group V metal. Specifically, the metal compound may further contain one or more metals selected from the group consisting of Zr, Hf, V, Nb, and Ta. In this case, the metal may be contained in the form of chloride, alkoxy chloride, alkylate, or the like, but this is only an example, and the metal is not limited thereto.

In an embodiment, the metal compound containing titanium (Ti) may contain TiX₄ or (R³O)_{z}Ti(X)_{4-z}. In this case, X is a halogen atom such as I, Br, Cl, or F, each R³ is independently a linear or branched C₁₋₁₀ alkyl, C₁₋₅ alkyl, C₂₋₆ alkyl, or C₁₋₅ alkyl, and z is an integer of 1 to 4 (for example, 1, 2, 3, or 4). Specific examples of the metal compound comprise TiCl₄, TiBr₄, Til₄, Ti(OBu)₄, Ti(Oi-Pr)₄, Ti(OEt)₄, Ti(OEt)₂(Cl)₂, and Ti(OEt) (Cl)₃. However, this is only an example, but the metal compound is not limited thereto.

In an embodiment, the metal compound containing titanium (Ti) may be a mixed metal compound further comprising a Group V metal compound. For example, the metal compound according to an embodiment may be a mixed metal compound of a metal compound (TiCl₄) containing titanium and a Group V metal compound (VOCl₃) containing a Group V metal.

In an embodiment, the number of moles of the branched alkyl alcohol or cycloalkyl alcohol added may exceed one times the number of moles of the dialkyl magnesium. For example, the number of moles of the branched alkyl alcohol or cycloalkyl alcohol added may be 1.2 times or more, 1.5 times or more, 2.0 times or more, 10 times or less, 8 times or less, 5 times or less, 4 times or less, or 3.5 times or less the number of r moles of the dialkyl magnesium.

Alternatively, a molar ratio of the dialkyl magnesium to the branched alkyl alcohol or cycloalkyl alcohol may be 1:1.2 to 1:10, 1:1.5 to 1:10, 1:1.5 to 1:8, 1:1.5 to 1:6, 1:1.5 to 1:5, 1:2 to 1:8, 1:2 to 1:4, or 1:1.5 to 1:3.5.

In an embodiment, the number of moles of the branched alkyl alcohol or cycloalkyl alcohol added may exceed two times the number of moles of the compound represented by Chemical Formula 1. For example, the number of moles of the branched alkyl alcohol or cycloalkyl alcohol added may be 2.2 times or more, 2.5 time or more, 3 times or more, 4 times or more, 10 times or less, 9 times or less, 8 times or less, or 7 times or less the number of moles of the compound represented by Chemical Formula 1. Alternatively, a molar ratio of the compound represented by Chemical Formula 1 to the branched alkyl alcohol or cycloalkyl alcohol may be 1:2.5 to 1:10, 1:2.5 to 1:9, 1:2.5 to 1:8, 1:2.5 to 1:7, 1:3 to 1:10, or 1:4 to 1:10.

In an embodiment, the adding of the branched alkyl alcohol or cycloalkyl alcohol may be performed at a temperature of about 10° C. to −50° C., 0° C. to −30° C., −5° C. to −25° C., or −10° C. to −20° C. In addition, after the adding of the branched alkyl alcohol or cycloalkyl alcohol, a step of allowing a reaction to proceed may be performed for about 120 minutes to 300 minutes, 180 minutes to 300 minutes, 200 minutes to 300 minutes, 220 minutes to 260 minutes, or about 240 minutes.

The branched alkyl alcohol according to an embodiment is not particularly limited as long as it is an alcohol substituted with a branched alkyl group, and examples thereof comprise a branched C₃₋₂₀ alkyl alcohol, a branched C₃₋₁₅ alkyl alcohol, a branched C₃₋₁₀ alkyl alcohol, a branched C₃₋₈ alkyl alcohol, a branched C₃₋₆ alkyl alcohol, a branched C₃₋₅ alkyl alcohol, or a branched C₃₋₄ alkyl alcohol. As a specific example, the branched alkyl alcohol may be isopropyl alcohol, isobutyl alcohol, tert-butyl alcohol, sec-butyl alcohol, 2-pentanol, 2-methyl-1-butanol, 3-methyl-1-butanol, 3-pentanol, neopentanol, 2-methyl-2-butanol, 3-methyl-2-butanol, 2-hexanol, 3-hexanol, 2-methyl-1-pentanol, 3-methyl-1-pentanol, 4-methyl-1-pentanol, 2-methyl-2-pentanol, 3-methyl-2-pentanol, 4-methyl-2-pentanol, 2-methyl-3-pentanol, 3-methyl-3-pentanol, 2,2-dimethyl-1-butanol, 2, 3-dimethyl-1-butanol, 3,3-dimethyl-1-butanol, 2,3-dimethyl-2-butanol, 3,3-dimethyl-2-butanol, 2-ethyl-1-butanol, or a combination of two or more thereof. In addition, the above alcohol is only an example, but is not limited as long as it is an alcohol having a branched alkyl chain.

The cycloalkyl alcohol according to an embodiment is not particularly limited as long as it is an alcohol substituted with a cyclic alkyl group, and may be a C₃₋₂₀ cycloalkyl alcohol, a C₃₋₁₅ cycloalkyl alcohol, C₃₋₁₀ cycloalkyl alcohol, a C₃₋₈ cycloalkyl alcohol, a C₃₋₆ cycloalkyl alcohol, a C₄₋₆ cycloalkyl alcohol, or a C₅₋₆ cycloalkyl alcohol. As a specific example, the cycloalkyl alcohol may be cyclopropanol, cyclobutanol, cyclopentanol, cyclohexanol, cycloheptanol, cyclooctanol, cyclononanaol, cyclodecanol, bicyclo[2.1.1]hexanol, bicyclo[2. 2. 1]heptanol, octahydropentalenol, octahydro-1H-indenol, or a combination of two or more thereof. Alternatively, the cycloalkyl alcohol according to an embodiment may comprise an alcohol substituted with cyclic alkyl group containing an unsaturated bond, or may comprise a structure in which a cycloalkyl group with is substituted an arbitrary substituent without limitation. In addition, the above cycloalkyl alcohol is only an example, but is not limited as long as it is an alcohol having a cycloalkyl group.

Another embodiment provides a Ziegler-Natta catalyst for polymerization of a low-density copolymer prepared by the method for preparing a Ziegler-Natta catalyst for polymerization of a low-density copolymer according to the embodiment.

Still another embodiment provides a method for producing a low-density copolymer using the Ziegler-Natta catalyst for polymerization of a low-density copolymer according to an embodiment. Specifically, there is provided a method for producing a low-density copolymer, the method comprising bringing an olefin monomer into contact with the Ziegler-Natta catalyst for polymerization of a low-density copolymer according to an embodiment.

In an embodiment, the olefin monomer may be, for example, an olefin monomer having 2 to 20, 2 to 15, or 4 to 10 carbon atoms.

In an embodiment, the low-density copolymer may be, for example, a linear low-density copolymer, and may be, for example, linear low-density polyethylene.

In an embodiment, a density of the low-density copolymer may be 0.91 g/mL to 0.94 g/mL, 0.912 g/mL to 0.938 g/mL, 0.915 g/mL to 0.935 g/mL, or 0.915 g/mL to 0.924 g/ml, but this is only an example, and the density of the low-density copolymer is not limited thereto. In an embodiment, a melt index (MI) of the low-density copolymer may be 0.1 g/10 min to 5.0 g/10 min, 0.1 g/10 min to 4.0 g/10 min, 0.1 g/10 min to 3.0 g/10 min, 0.1 g/10 min to 2.0 g/10 min, 0.1 g/10 min to 1.0 g/10 min, 0.2 g/10 min to 1.0 g/10 min, 0.4 g/10 min to 1.0 g/10 min, or 0.5 g/10 min to 0.9 g/10 min, when measured at about 190° C. according to ISO 1133:1997 or ASTM D1238: 1999, but this is only an example, and the melt index of the low-density copolymer is not limited thereto.

### MODE FOR INVENTION

Hereinafter, Examples and Experimental Examples will be described in detail below. However, Examples and Experimental Examples to be described below are merely illustrative of a part of an embodiment, and the technology described in the present specification is not limited thereto.

### Examples 1-1 to 1-4

Into a 500 mL flask, 33 mL (30.0 mmol) of a 0.9 M ethyl normal butyl magnesium (BEM, [dialkyl magnesium]) heptane solution was injected, and then 100 mL of normal heptane was injected. 3.50 g (15.0 mmol) of triethyl aluminum (AlEt₃, [aluminum compound-1]) was slowly added dropwise while stirring the solution. Thereafter, isopropyl alcohol (i-PrOH, [alcohol]) was slowly added dropwise in equivalents as shown in Table 1, and the reaction was sufficiently conducted for about 4 hours while maintaining the reaction temperature at about 0° C. to −30° C., thereby preparing a 0.2 M magnesium support slurry solution.

30 mL (6.00 mmol) of the 0.2 M magnesium support slurry solution ([support]) was injected into a 100 mL flask, 3.3 mL (0.40 mmol) of a 5 wt % Ti(Oi-Pr) 4 ([metal compound]) heptane solution was injected, and stirring was performed for 4 hours or longer. Thereafter, 2 mL (2.00 mmol) of a 1.0 M ethyl aluminum dichloride solution (C₂H₅AlCl₂, [aluminum compound-2]) diluted in hexane was injected, and stirring was performed at room temperature for 6 hours or longer, thereby preparing a reddish-brown catalyst (Ziegler-Natta) solution.

### Examples 2-1 to 2-4

Reddish-brown catalyst (Ziegler-Natta) solutions were prepared in the same manner as those of Examples 1-1 to 1-4 except that [metal compound] was changed to 3.28 mL (0.40 mmol) of a 5 wt % TiCl₄ heptane solution.

### Examples 3-1 to 3-4

Reddish-brown catalyst (Ziegler-Natta) solutions were prepared in the same manner as those of Examples 1-1 to 1-4 except that [aluminum compound-1] was changed to 2.97 g (15.0 mmol) of triisobutyl aluminum (Al (i-Bu) 3).

### Examples 4-1 to 4-4

Reddish-brown catalyst (Ziegler-Natta) solutions were prepared in the same manner as those of Examples 1-1 to 1-4 except that [alcohol] was changed to isobutyl alcohol (i-BuOH).

### Examples 5-1 to 5-4

Reddish-brown catalyst (Ziegler-Natta) solutions were prepared in the same manner as those of Examples 1-1 to 1-4 except that [alcohol] was changed to 2-methyl-2-propyl alcohol (t-BuOH).

### Examples 6-1 to 6-4

Reddish-brown catalyst (Ziegler-Natta) solutions were prepared in the same manner as those of Examples 1-1 to 1-4 except that [alcohol] was changed to cyclohexanol (CHN).

### Comparative Examples 1-1 to 1-4

Into a 500 mL flask, 33 mL (30.0 mmol) of a 0.9 M ethyl normal butyl magnesium (BEM, [dialkyl magnesium]) heptane solution was injected, and then 120 mL of normal heptane was injected. 2.97 g (15.0 mmol) of triisobutyl aluminum (Al (i-Bu) 3, [aluminum compound-1]) was slowly added dropwise while stirring the solution. Thereafter, normal propyl alcohol (n-PrOH, [alcohol]) was slowly added dropwise in equivalents as shown in Table 1, and the reaction was sufficiently conducted for about 4 hours while maintaining the reaction temperature at about 0° C. to −30° C., thereby preparing a 0.2 M transparent magnesium support slurry solution.

30 mL (6.00 mmol) of the 0.2 M magnesium support slurry solution ([support]) was injected into a 100 mL flask, 0.36 mL (0.34 g, 1.20 mmol) of a Ti(Oi-Pr) 4 ([metal compound]) heptane solution was injected, and stirring was performed for 4 hours or longer. Thereafter, 24.00 mL (24.00 mmol) of a 1.0 M ethyl aluminum dichloride solution (C₂H₅AlCl₂, [aluminum compound-2]) diluted in hexane was injected, and stirring was performed at room temperature for 6 hours or longer, thereby preparing a brown catalyst (Ziegler-Natta) solution.

### Comparative Examples 2-1 to 2-4

Catalyst (Ziegler-Natta) solutions were prepared in the same manner as those of Comparative Examples 1-1 to 1-4 except that [aluminum compound-1] was changed to triethyl alcohol (AlEt₃).

### Comparative Examples 3-1 to 3-4

Catalyst (Ziegler-Natta) solutions were prepared in the same manner as those of Examples 1-1 to 1-4 except that [alcohol] was changed to normal butyl alcohol (n-BuOH).

TABLE 1

| | Dialkyl | Aluminum | |
|---|---|---|---|
| | magnesium | compound-1 | Alcohol |
| Example 1-1 | A, 1.0 equiv. | B, 0.5 equiv. | D, 1.0 equiv. |
| Example 1-2 | | | D, 2.0 equiv. |
| Example 1-3 | | | D, 3.0 equiv. |
| Example 1-4 | | | D, 3.5 equiv. |
| Example 2-1 | A, 1.0 equiv. | B, 0.5 equiv. | D, 1.0 equiv. |
| Example 2-2 | | | D, 2.0 equiv. |
| Example 2-3 | | | D, 3.0 equiv. |
| Example 2-4 | | | D, 3.5 equiv. |
| Example 3-1 | A, 1.0 equiv. | C, 0.5 equiv. | D, 1.0 equiv. |
| Example 3-2 | | | D, 2.0 equiv. |
| Example 3-3 | | | D, 3.0 equiv. |
| Example 3-4 | | | D, 3.5 equiv. |
| Example 4-1 | A, 1.0 equiv. | B, 0.5 equiv. | E, 1.0 equiv. |
| Example 4-2 | | | E, 2.0 equiv. |
| Example 4-3 | | | E, 3.0 equiv. |
| Example 4-4 | | | E, 3.5 equiv. |
| Example 5-1 | A, 1.0 equiv. | B, 0.5 equiv. | F, 1.0 equiv. |
| Example 5-2 | | | F, 2.0 equiv. |
| Example 5-3 | | | F, 3.0 equiv. |
| Example 5-4 | | | F, 3.5 equiv. |
| Example 6-1 | A, 1.0 equiv. | B, 0.5 equiv. | G, 1.0 equiv. |
| Example 6-2 | | | G, 2.0 equiv. |
| Example 6-3 | | | G, 3.0 equiv. |
| Example 6-4 | | | G, 3.5 equiv. |
| Comparative | A, 1.0 equiv. | C, 0.5 equiv. | H, 1.0 equiv. |
| Example 1-1 | | | |
| Comparative | | | H, 2.0 equiv. |
| Example 1-2 | | | |
| Comparative | | | H, 3.0 equiv. |
| Example 1-3 | | | |
| Comparative | | | H, 3.5 equiv. |
| Example 1-4 | | | |
| Comparative | A, 1.0 equiv. | B, 0.5 equiv. | H, 1.0 equiv. |
| Example 2-1 | | | |
| Comparative | | | H, 2.0 equiv. |
| Example 2-2 | | | |
| Comparative | | | H, 3.0 equiv. |
| Example 2-3 | | | |
| Comparative | | | H, 3.5 equiv. |
| Example 2-4 | | | |
| Comparative | A, 1.0 equiv. | B, 0.5 equiv. | I, 1.0 equiv. |
| Example 3-1 | | | |
| Comparative | | | I, 2.0 equiv. |
| Example 3-2 | | | |
| Comparative | | | I, 3.0 equiv. |
| Example 3-3 | | | |
| Comparative | | | I, 3.5 equiv. |
| Example 3-4 | | | |

1) Dialkyl magnesium
A: BEM
2) Aluminum compound-1
B: AlEt₃/C: Al (i-Bu)₃
3) Alcohol
D: i-PrOH/E: i-BuOH/F: t-BuOH/G: CHN/H: n-PrOH/I: n-BuOH

TABLE 2

| | | Metal | Aluminum |
|---|---|---|---|
| | Support | compound | compound-2 |
| Examples 1-1 | 15.0 equiv. | J, 1.0 equiv. | L, 5.0 equiv. |
| to 1-4 | | | |
| Examples 2-1 | 15.0 equiv. | K, 1.0 equiv. | L, 5.0 equiv. |
| to 2-4 | | | |
| Examples 3-1 | 15.0 equiv. | J, 1.0 equiv. | L, 5.0 equiv. |
| to 3-4 | | | |
| Examples 4-1 | 15.0 equiv. | J, 1.0 equiv. | L, 5.0 equiv. |
| to 4-4 | | | |
| Examples 5-1 | 15.0 equiv. | J, 1.0 equiv. | L, 5.0 equiv. |
| to 5-4 | | | |
| Examples 6-1 | 15.0 equiv. | J, 1.0 equiv. | L, 5.0 equiv. |
| to 6-4 | | | |
| Comparative | 5.0 equiv. | J, 1.0 equiv. | L, 20.0 equiv. |
| Examples 1-1 | | | |
| to 1-4 | | | |
| Comparative | 5.0 equiv. | J, 1.0 equiv. | L, 20.0 equiv. |
| Examples 2-1 | | | |
| to 2-4 | | | |
| Comparative | 15.0 equiv. | J, 1.0 equiv. | L, 5.0 equiv. |
| Examples 3-1 | | | |
| to 3-4 | | | |

1) Metal compound
J: Ti (Oi-Pr)₄/K: TiCl₄
2) Aluminum compound-2
L: C₂H₅AlCl₂

### <Experimental Example 1> Polymerization of Low-Density Copolymer

An autoclave reactor was filled with 0.5 L of a saturated hydrocarbon solvent (methylcyclohexane) in a stable anhydrous nitrogen state, 0.2 g (0.15 mol) of triethyl aluminum and 100 mL (70 g, 0.7 mol) of 1-octene were injected, the temperature of the reactor was raised to 180° C., stirring was performed, and then ethylene was injected into the reactor at 30 bar. 1.7 μmol of each of the catalysts prepared in Examples 1-4, 2-4, 3-4, 4-4, 5-4, and 6-4 and Comparative Examples 1~4 and 3-4 was diluted with 3 mL of a saturated hydrocarbon solvent (methylcyclohexane), the diluted catalyst was transferred to a catalyst port, and the catalyst port was pressurized with anhydrous nitrogen at 50 bar. After the inside of the autoclave reactor was saturated with ethylene, the catalyst was injected from the catalyst port into the reactor under an isothermal condition of 180° C., and semi-batch polymerization with a continuous supply of ethylene was performed for 10 minutes. Thereafter, the reactant was recovered through an outlet and the solvent was dried to obtain a linear low-density copolymer (linear low-density polyethylene (LLDPE)). The yield, catalyst mileage, melt index, and density of the obtained linear low-density polyethylene were measured. The results thereof are shown in Table 3.

At this time, the catalyst mileage was defined as a value obtained by dividing the mass of the produced LLDPE by the mass of the catalyst. The melt index was measured by conducting a test at 190° C. according to the ASTM D1238 standard, and the density was measured with a density gradient column.

TABLE 3

| | LLDPE | Catalyst mileage | | |
|---|---|---|---|---|
| | yield | (LLDPE ton/Kg | MI | Density |
| | (g) | of catalyst) | (g/10 min) | (g/mL) |
| Example 1-4 | 40.70 | 22.00 | 0.86 | 0.9186 |
| Example 2-4 | 31.60 | 17.08 | 0.52 | 0.9220 |
| Example 3-4 | 36.32 | 19.63 | 0.70 | 0.9218 |
| Example 4-4 | 25.12 | 13.58 | 0.60 | 0.9219 |
| Example 5-4 | 16.10 | 8.70 | 0.81 | 0.9226 |
| Example 6-4 | 23.12 | 12.50 | 0.52 | 0.9225 |
| Comparative | 10.00 | 3.79 | 0.35 | 0.9227 |
| Example 1-4 | | | | |
| Comparative | 13.85 | 7.49 | 0.28 | 0.9301 |
| Example 3-4 | | | | |

Referring to Table 3, it can be seen that the yield of the copolymer is significantly increased when the polymerization is performed using the catalysts prepared in Examples and the catalyst mileage value is increased, compared to the case where the polymerization is performed using the catalysts prepared in Comparative Examples.

### <Experimental Example 2>Crystallization Elution Fractionation (CEF)

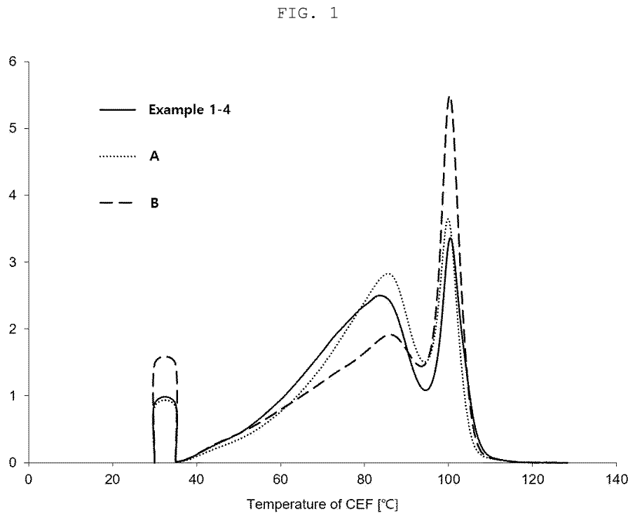

In order to analyze the physical properties of the polymer prepared using the catalyst of Example 1-4 through crystallization elution fractionation (CEF), a test was conducted using POLYMER-CHAR CRYTEX-42 instrument and a trichlorobenzene (TCB) solution. At this time, commercial product A (Dow Chemical Company (DOWLEX 2045G), MI: 1.00 g/10 min, density: 0.9200 g/mL) and commercial product B(SK Chemicals Co., Ltd. (FN810), MI: 0.99, density: 0.9198 g/mL) were prepared and tested as comparative groups. The results are illustrated in FIG. 1.

Through the above experiments, it could be confirmed that, in the cases of the polymers produced using the catalysts of Examples, the ratio of the high density region (homopolymer) at about 80° C. to 100° C. was low and the ratio of the low density region (copolymer) at about 50° C. to 80° C. was high in the CEF spectrum compared to the commercial products. Therefore, it can be seen that a low-density copolymer having a high elongation may be effectively prepared using the catalysts of Examples.

### <Experimental Example 3>Analysis of Form of Magnesium Support Solution

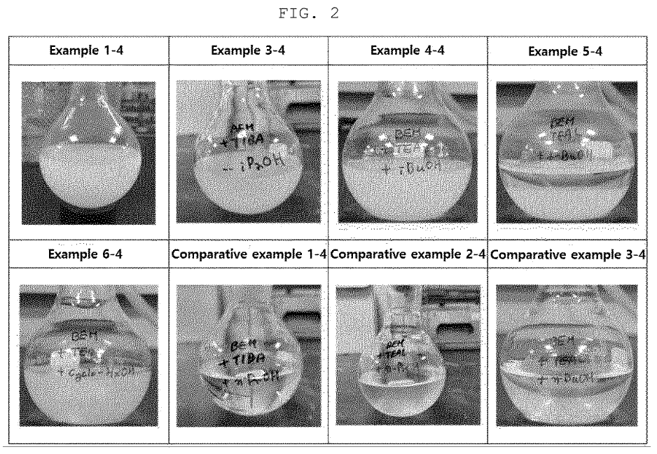

In order to analyze the transparency and solubility of the magnesium support solutions according to the type of alcohol solvent, the forms of the magnesium support solutions prepared in Examples and Comparative Examples were observed. The results thereof are shown in Table 4. Among them, photographs of the magnesium support solutions prepared in Examples 1-4, 3-4, 4-4, 5-4, and 6-4 and Comparative Examples 1-4, 2-4, and 3-4 were captured. The photographs are illustrated in FIG. 2.

TABLE 4

| | Alcohol | Form of support solution |
|---|---|---|
| Example 1-1 | D, 1.0 equiv. | TS |
| Example 1-2 | D, 2.0 equiv. | OS |
| Example 1-3 | D, 3.0 equiv. | OS |
| Example 1-4 | D, 3.5 equiv. | OS |
| Example 3-1 | D, 1.0 equiv. | TS |
| Example 3-2 | D, 2.0 equiv. | OS |
| Example 3-3 | D, 3.0 equiv. | OS |
| Example 3-4 | D, 3.5 equiv. | OS |
| Example 4-1 | E, 1.0 equiv. | TS |
| Example 4-2 | E, 2.0 equiv. | OS |
| Example 4-3 | E, 3.0 equiv. | OS |
| Example 4-4 | E, 3.5 equiv. | OS |
| Example 5-1 | F, 1.0 equiv. | TS |
| Example 5-2 | F, 2.0 equiv. | OS |
| Example 5-3 | F, 3.0 equiv. | OS |
| Example 5-4 | F, 3.5 equiv. | OS |
| Example 6-1 | G, 1.0 equiv. | TS |
| Example 6-2 | G, 2.0 equiv. | OS |
| Example 6-3 | G, 3.0 equiv. | OS |
| Example 6-4 | G, 3.5 equiv. | OS |
| Comparative | H, 1.0 equiv. | TS |
| Example 1-1 | | |
| Comparative | H, 2.0 equiv. | TS |
| Example 1-2 | | |
| Comparative | H, 3.0 equiv. | TS |
| Example 1-3 | | |
| Comparative | H, 3.5 equiv. | TS |
| Example 1-4 | | |
| Comparative | H, 1.0 equiv. | TS |
| Example 2-1 | | |
| Comparative | H, 2.0 equiv. | TS |
| Example 2-2 | | |
| Comparative | H, 3.0 equiv. | TS |
| Example 2-3 | | |
| Comparative | H, 3.5 equiv. | TS |
| Example 2-4 | | |
| Comparative | I, 1.0 equiv. | TS |
| Example 3-1 | | |
| Comparative | I, 2.0 equiv. | TS |
| Example 3-2 | | |
| Comparative | I, 3.0 equiv. | TS |
| Example 3-3 | | |
| Comparative | I, 3.5 equiv. | TS |
| Example 3-4 | | |

TS: Transparent Solution
OS: Opaque Slurry

As can be seen in Table 4 and FIG. 2, the magnesium support solution prepared using a branched alkyl alcohol or cycloalkyl alcohol as a solvent was observed to be opaque, and the magnesium support solution prepared using a linear alkyl alcohol as a solvent was observed to be transparent. Through this, it could be confirmed that the alcohol solvent greatly contributed to the form of the solution in the preparation of the magnesium support solution. In particular, it can be seen that a magnesium support having significantly stabilized physical properties may be prepared using a branched alkyl-substituted alcohol such as isopropyl, isobutyl, or tert-butyl or a cyclic alkyl-substituted alcohol such as cyclohexane, and a Ziegler-Natta catalyst having high activity for producing a low-density copolymer may be prepared using the magnesium support.

Hereinabove, one embodiment has been described in detail through preferred Examples and Experimental Examples, but the scope of one embodiment is not limited to a specific embodiment, and should be interpreted according to the appended claims.

1. A method for preparing a Ziegler-Natta catalyst for polymerization of a low-density copolymer comprising:
adding a branched alkyl alcohol or cycloalkyl alcohol to a mixture of dialkyl magnesium and a compound represented by the following Chemical Formula 1 to prepare a solution containing a magnesium support; and
adding a metal compound containing titanium (Ti) to the solution containing the magnesium support: 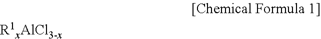
in Chemical Formula 1,
each R¹ is independently C₁₋₁₀ alkyl or C₃₋₁₀ cycloalkyl; and
x is 1 to 3.

2. The method of claim 1, further comprising, after the adding of the metal compound, adding a compound represented by the following Chemical Formula 2: 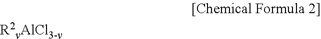
in Chemical Formula 2,
each R² is independently C₁₋₁₀ alkyl or C₃₋₁₀ cycloalkyl; a y is 1 to 2.

3. The method of claim 1, wherein each R¹ is independently C₁₋₆ alkyl or C₃₋₆ cycloalkyl.

4. The method of claim 1, wherein the number of moles of the branched alkyl alcohol or cycloalkyl alcohol added exceeds one times the number of moles of the dialkyl magnesium.

5. The method of claim 1, wherein the number of moles of the branched alkyl alcohol or cycloalkyl alcohol added exceeds two times the number of moles of the compound represented by Chemical Formula 1.

6. The method of claim 2, wherein each R² is independently C₁₋₆ alkyl or C₃₋₆ cycloalkyl.

7. The method of claim 2, wherein the compound represented by Chemical Formula a 2 is EtAlCl₂, MeAlCl₂, PrAlCl₂, BuAlCl₂, or (C₂H₅) 3/2AlCl_{3/2}.

8. The method of claim 2, wherein a molar ratio of the metal compound to the compound represented by Chemical Formula 2 is 1:0.1 to 1:15.

9. The method of claim 1, wherein a molar ratio of the metal compound to the magnesium support is 1:5 to 1:30.

10. The method of claim 1, wherein the metal compound further contains a Group IV or Group V metal.

11. The method of claim 1, wherein the metal compound contains TiX₄ or (R³O)_{z}Ti(X)_{4-z} where X is a halogen atom, each R³ is independently C₁₋₁₀ alkyl, and z is an integer of 1 to 4.

12. The method of claim 11, wherein the metal compound is a mixed metal compound further containing a compound containing a Group V metal.

13. The method of claim 1, wherein the branched alkyl alcohol is a branched C₃₋₁₀ alkyl alcohol.

14. The method of claim 1, wherein the branched alkyl alcohol is one or a combination of two or more selected from isopropyl alcohol, isobutyl alcohol, and tert-butyl alcohol.

15. The method of claim 1, wherein the cycloalkyl alcohol is a C₃₋₁₀ cycloalkyl alcohol.

16. The method of claim 1, wherein the cycloalkyl alcohol is cyclohexanol.

17. A Ziegler-Natta catalyst for polymerization of a low-density copolymer prepared by the method for preparing a Ziegler-Natta catalyst for polymerization of a low-density copolymer of claim 1.

18. A method for producing a low-density copolymer, comprising bringing an olefin monomer into contact with the Ziegler-Natta catalyst for polymerization of a low-density copolymer of claim 17.

19. The method of claim 18, wherein a density of the low-density copolymer is 0.91 g/mL to 0.94 g/mL, and a melt index (MI) of the low-density copolymer is 0.1 g/10 min to 5.0 g/10 min when measured according to ASTM D1238.
